(19) United States
(12) Patent Application Publication
(10) Pub. No.: US 2004/0203693 A1
(43) Pub. Date: Oct. 14, 2004

(54) Over the air firmware and policy programming

(75) Inventors: Pratik M. Mehta, Austin, TX (US); Liam B. Quinn, Austin, TX (US); Alan E. Sicher, Austin, TX (US)

Correspondence Address: BAKER BOTTS, LLP, 910 LOUISIANA, HOUSTON, TX, 77002-4995, US

(73) Assignee: Dell Products L.P., Round Rock, TX

(21) Appl. No.: 10/246,311

(22) Filed: Sep. 18, 2002

(51) Int. Cl. H04M 3/00; H04M 1/00; H04B 1/38

(52) U.S. Cl. 455/419; 455/418; 455/550.1

(57) ABSTRACT

A method and system for upgrading communication components in a wireless information handling system. The method and system includes connecting the wireless information handling system to a server computer. The server computer has status as to the most current software configuration and is able to determine if the wireless information system has the desired configuration. The download of software is then performed to the wireless information handling device from the server.

### TECHNICAL FIELD OF THE DISCLOSURE

The present disclosure relates generally to a method and system for monitoring, upgrading and downloading communication configuration modifications in wireless computing devices.

### BACKGROUND

As the value and use of information continues to increase, individuals and businesses seek additional ways to process and store information. One option available to users is the information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more information handling systems, data storage systems, and networking systems.

Included as information handling systems are portable personal computers (PCs) known commonly as laptops and notebook computers, personal digital assistants (PDAs), and other mobile computing systems. These particular information handling systems have the advantage of mobility over their stationary counterpart, the desktop PC. Mobile information handling devices through modems, network interface cards (NIC), and other communication interfaces are generally able to connect to networks, computers, and peripheral devices.

Communication components typically can be modified or upgraded in terms of software and firmware to allow for more diverse operation of the components as well as operation in varying locations. Oftentimes, in the rush to get mobile computing devices to consumers, the mobile computing devices are manufactured with immature communication components including NICs and modems. Immature communication components are components that include basic software or firmware, which supports the mobile information handling device hardware with a limited liability. In order to provide the communication component with greater communication ability, the immature communication component is upgraded with a modified software or firmware.

However, where a mobile information handling device communicates in a particular wireless access network, a mobile user may relocate to a different wireless access network. Because different wireless access networks can require different standards and protocols, communication components within the mobile information handling device may need to be modified to operate within the different wireless access network. Typically, a mobile user is not aware of nor has knowledge of the requirements to initiate communication on the different wireless access network. Additionally, the mobile information handling device may be unable to connect to the peripherals in the different network because the mobile information handling device does not have the necessary identification codes or parameters to connect to the peripherals.

Even if the user is aware of the specific requirements, the user has no means of downloading the modifications to the mobile information handling device. Once the user is within the different wireless access network, the mobile information handling device may not be able to communicate with the different network. Thus, the user must have downloaded the modifications prior to traveling within the different returns.

Institutions, such as businesses and government agencies, have information technology (IT) centers that generally track and monitor information handling devices such as desktop PCs, mobile PCs, and PDAs for use with their wireless network. With a managed network connected to desktop PCs, IT centers can track the configuration of specific desktop PC machines for compatibility. Due to their nomadic nature, the configuration of mobile information handling devices is more difficult to monitor and track as they are able to move outside of the wireless returns. If given the ability to track and devices, IT centers can determine if a configuration of mobile information handling devices is updated and initiate the necessary modifications to the mobile information handling devices where desired.

### SUMMARY

In accordance with teachings of the present disclosure, a system and method are described for monitoring and upgrading communication components in a mobile information handling device in order to provide the proper communication configuration.

In an embodiment, a wireless information handling device connects to a server. Then, a determination is made as to the particular software revision status of the wireless information handling device. A software download may then be performed from the server if the revision status requires a software update.

In certain embodiments, predetermined parameters may be programmed into the wireless information handling device. When the parameters are met, a software upgrade is preferably initiated.

In other embodiments, a server may actively connect and determine the software status of the wireless information handling device. The server may then initiate one or more upgrades to the wireless information handling device.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

The present disclosure may be better understood, and its numerous objects, features and advantages made apparent to those skilled in the art by referencing the accompanying drawings. The use of the same reference number throughout the figures designates a like or similar element.

FIG. 1 is a block diagram illustrating one embodiment of a wireless network environment according to teachings of the present disclosure;

FIG. 1A is a block diagram illustrating one embodiment of a client connecting to various peripherals in a wireless environment according to teachings of the present disclosure;

FIG. 2 is a block diagram illustrating the protocol stack layers in a mobile information handling device according to teachings of the present disclosure;

FIG. 3 is a block diagram illustrating an expanded data link layer according to teachings of the present disclosure;

FIG. 4 is a flow diagram illustrating a method for updating a mobile information handling device incorporating teachings of the present disclosure;

FIG. 5 is a flow diagram illustrating a method for file download updating incorporating teachings of the present disclosure;

FIG. 6 is a block diagram illustrating a network environment in which a system according to the present disclosure may be practiced;

FIG. 7 is a block diagram illustrating a computer system incorporating teachings of the present disclosure; and

FIG. 8 is a block diagram illustrating a network in which a computer system is coupled to an internetwork according to teachings of the present disclosure.

While the present disclosure is susceptible to various modifications and alternative forms, specific embodiments thereof are shown by way of example in the drawings and will herein be described, it should be understood, however, that the drawings and detailed description thereto are not intended to limit the invention to the particular form disclosed but on the contrary, the intention is to cover all modifications, equivalents, and alternatives falling within the scope of the present invention as defined by the appended claims.

### DETAILED DESCRIPTION

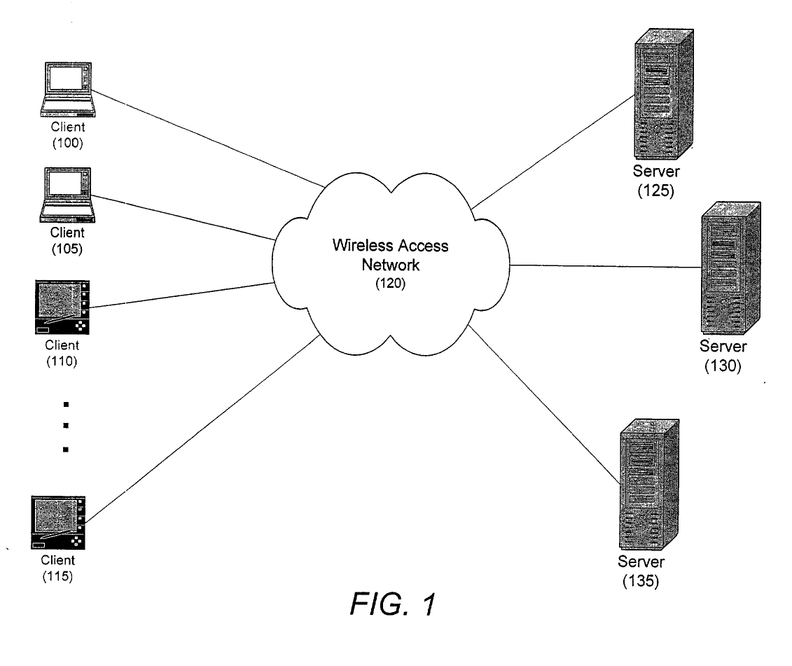

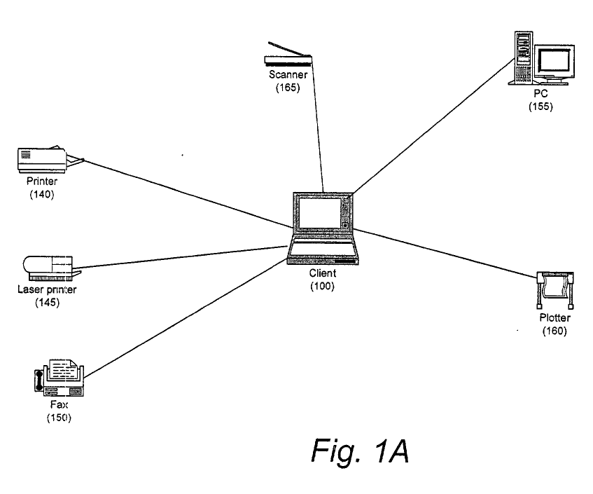

Preferred embodiments and their advantages are best understood by reference to FIGS. 1 through 8, wherein like numbers may be used to indicate like and corresponding parts. The following is intended to provide a detailed description and should not be taken to be limiting of the disclosure itself. Rather, any number of variations may fall within the scope of the present disclosure which is defined in the claims following the description.

Introduction

The present disclosure provides a method and apparatus in a manner that will be made clear in the following portions of this detailed description. The present disclosure discloses a technique for effecting software upgrades to a wireless information handling device, in particular to the communication components that are able to be upgraded with software.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, one or more disk drives, and/or other types of nonvolatile memory. Additional components of the information handling system may include one or more network ports for communicating with external devices as well as various input and output (I/O) devices, such as a keyboard, a mouse, and a video display. The information handling system may also include one or more buses operable to transmit communications between the various hardware components.

Wireless Network

Referring to FIG. 1, illustrated is a block diagram of a wireless network. A number of mobile information handling devices or clients 100, 105, 110, and 115 are connected to wireless network 120. Wireless access network 120 may include various wireless wide area networks (WWAN), wireless local area networks (WLAN), wireless personal area networks (WPAN), a number of computers, transmitters, relays, and antennas operable to interconnect clients 100, 105, 110 and 115 with one another, to other computers, and peripheral devices. Wireless network 120 may also connect computer servers 125, 130, and 135. Servers 125, 130, 135 may be used to clients 100, 105, 110, and 115. Servers 125, 130, and 135 are preferably not limited in connectivity to wireless access network 120. It is contemplated that servers 125, 130, and 135 may be connected to other networks, wireless, wired, and/or some combination thereof. The interconnection of servers 125, 130, and 135 may be independent from the wireless connection to clients 100, 105, 110, and 115.

In an embodiment, server 125 is an over the air enterprise access policy provisioning server. Server 130 is an over the air authentication/security provisioning policy server operable to monitor and track the configuration of clients 100, 105, 110, and 115. Server 135 may be a third party server containing software changes and/or upgrades for clients 100, 105, 110, and 115. Server 125 preferably continually checks and monitors clients 100, 105, 110, and 115 to determine their particular communication configuration. If a determination is made to upgrade the software or firmware of a particular client, server 125 preferably directs the particular client to perform the modification by downloading software to revise the communication configuration. In certain embodiments, the required software or firmware for upgrading communications components may reside on server 125. In other embodiments, server 125 may redirect particular clients to other servers such as server 135 for selected software upgrades. Server 125 is preferably responsible for determining and tracking current configurations of clients 105, 110, 115, and 115. In addition, server 125 preferably communicates with other servers, such as servers 130 and 135 as to the latest software versions that are available. Although software updates may be available to clients 100, 105, 110, and 115, server 125 preferably determines if such updates are applicable and whether such changes should be downloaded to clients 100, 105, 110, and 115. If an update is determined to be required, server 125 may direct clients 100, 105, 110, and 115 to perform the modifications. Modifications and upgrades may include providing clients 100, 105, 110, and 115 with necessary identification and access codes for accessing peripherals in one or more wireless environments. Wireless connectivity between clients 100, 105, 110, and 115 and peripherals may include communication protocols such as “Bluetooth,” IEEE 802.11 b/a, or any other similarly enabled standard.

Now referring to FIG. 1A, illustrated is a block diagram of a client networked with various peripheral devices. When mobile information handling device client 100 is updated to communicate with a particular wireless network environment, particular identifications numbers and/or access codes are preferably provided as to the various peripherals. In such an example, client 100 is preferably enabled to access printer 140, laser printer 145, fax machine 150, PC (Personal Computer) 155, plotter 160, and scanner 165. Identification numbers and access codes to peripherals may be updated and changed and provided to wireless mobile information handling devices by such servers as those illustrated in FIG. 1, as required.

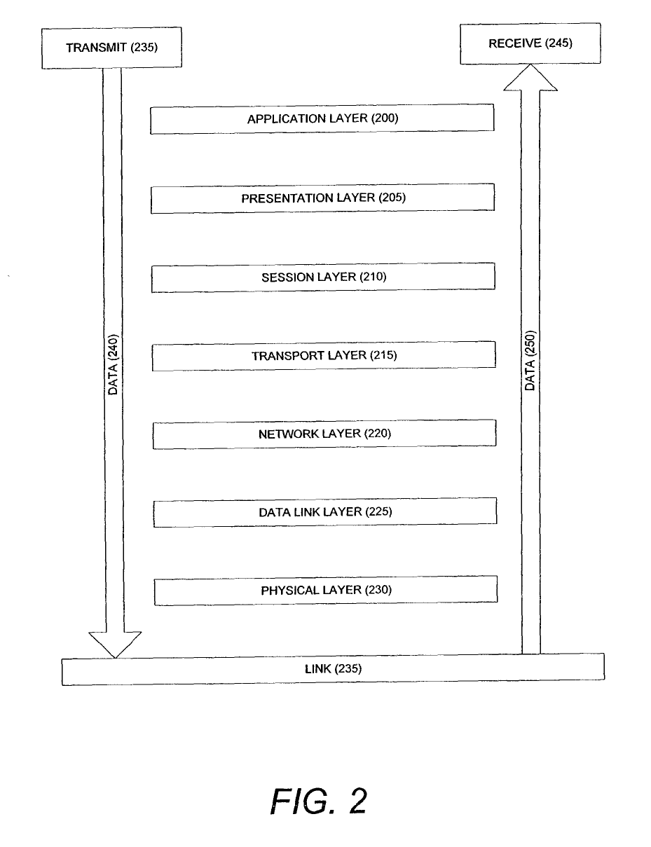

Now referring to FIG. 2, illustrated is a block diagram of the communication layers of the open system interconnection (OSI) model. The OSI model generally defines a networking framework for the implementation of protocols for the seven layers. The seven layers include application layer 200, presentation layer 205, session layer 210, transport layer 215, network layer 220, data link layer 225, and physical layer 230. Transmit device 235 preferably sends data 240, which generally passes through the control of the seven OSI layers, the seven OSI layers preferably being resident on transmit device 235 in one or more software applications and/or hardware components. Data 240 is eventually passed onto link 235. In particular embodiments, link 235 may be a wireless link. Receive device 245 preferably receives data 240 as data 250. As illustrated, data 250 is generally processed in reverse order through all seven OSI layers resident on receive device 245.

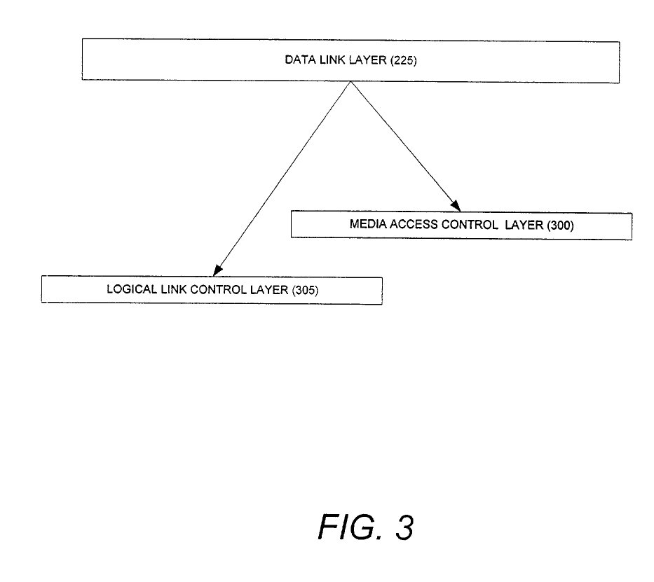

Now referring to FIG. 3, illustrated is a block diagram of an expanded data link layer. Data link layer 225 typically includes two layers, logical link control (LLC) layer 300 and media access control (MAC) layer 305. LLC layer 300 generally controls frame synchronization, flow control, and error checking. MAC layer 305 generally controls how a computer device on a network gains access to data and permission to transmit data. In certain embodiments, modifications may be made to MAC layer 305.

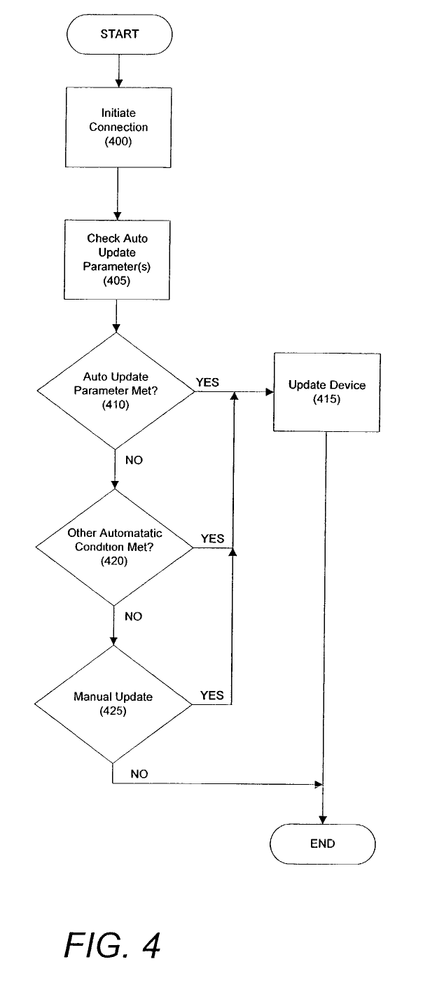

Now referring to FIG. 4, illustrated is a flowchart describing one method for updating a mobile information handling device. Connection is initiated between a mobile information handling device and a server at step 400. A mobile information handling device may have automatic update parameters that are built in and checked by the server. If automatic update parameters are made available, the server may check these automatic update parameters and determine whether the parameters are set or not at step 405. A check is preferably made as to whether the automatic update parameter is met at step 410. If an automatic update parameter is met, the device may be selected for updating at step 415. If an automatic update parameter is not met, other server-determined automatic-conditions may be checked at step 420. If such automatic conditions are met, the device is preferably selected for updating at step 415. If the automatic conditions are not met, the user may be queried as to whether an update is desired at step 425. If the operator desires an update, the device may then be updated at step 415. If all tests for updating fail, the process preferably ends.

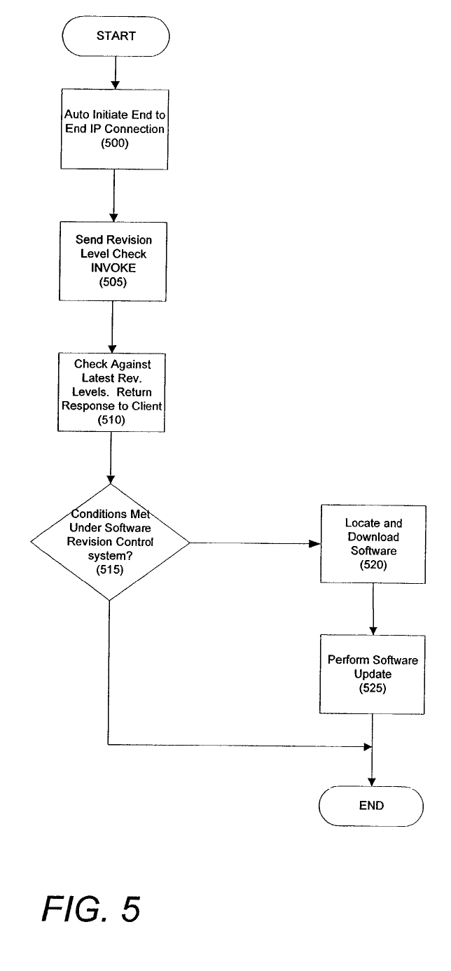

Now referring to FIG. 5, illustrated is a flowchart describing one method for file download updating. According to the method illustrated in FIG. 5, a client preferably initiates a connection to a server, in particular embodiments the connection is preferably made by an internet protocol (IP) connection at step 500. Step 500 may be performed with respect to one or sequentially to more than one server. The client preferably sends a revision level check INVOKE message to the one or more servers at step 505. Preferably accompanying the INVOKE message are file references and revisions, such as those file references and revisions for updating the client.

A check is preferably performed by the receiving server against the latest software levels and a RESPONSE message is then preferably sent back to the client regarding revision-level-check at step 510. In certain embodiments, one or more conditions may be checked in predetermined system software revision controls at step 515. A server or the client may perform such a check. In certain embodiments where a client performs the check, simple mail transfer protocol (SMTP) or hyper text transfer protocol (HTTP) may be used. SMTP is generally a protocol for sending e-mail messages and is commonly used over the Internet. SMTP messages provided to the client may include revision level checking information.

If the conditions in step 515 are not met, the process ends. If conditions are met in step 515, software may be located and downloaded at step 520. Clients are preferably always made aware of the locations of servers. In particular, clients are preferably always made aware of the locations of servers containing particular software updates. Other methods of providing server information may include providing a directory service to locate servers.

When the appropriate server or servers are located, the software is preferably downloaded to the client at step 525. A file update INVOKE may be initiated by the client to the appropriate provisioning server(s). The provisioning server(s) generally responds by sending the appropriate file or files, or portions of files to the requesting client. In certain embodiments, Internet file transfer protocol (FTP) is preferably used. FTP provides a structured protocol that enables file transfer between a client and server. In cases where the file downloads fail, re-initiation or a return to last known state takes place. A complete abort of the download may also take place.

When the preferred files have been downloaded, the client preferably creates a backup of the files, and replaces the selected files with updated versions. Updating can be performed while connected to a particular server or when the client is disconnected. Certain embodiments preferably provide for the user to predetermine certain configurations and filter out future software changes from being downloaded.

An Example Computing and Network Environment

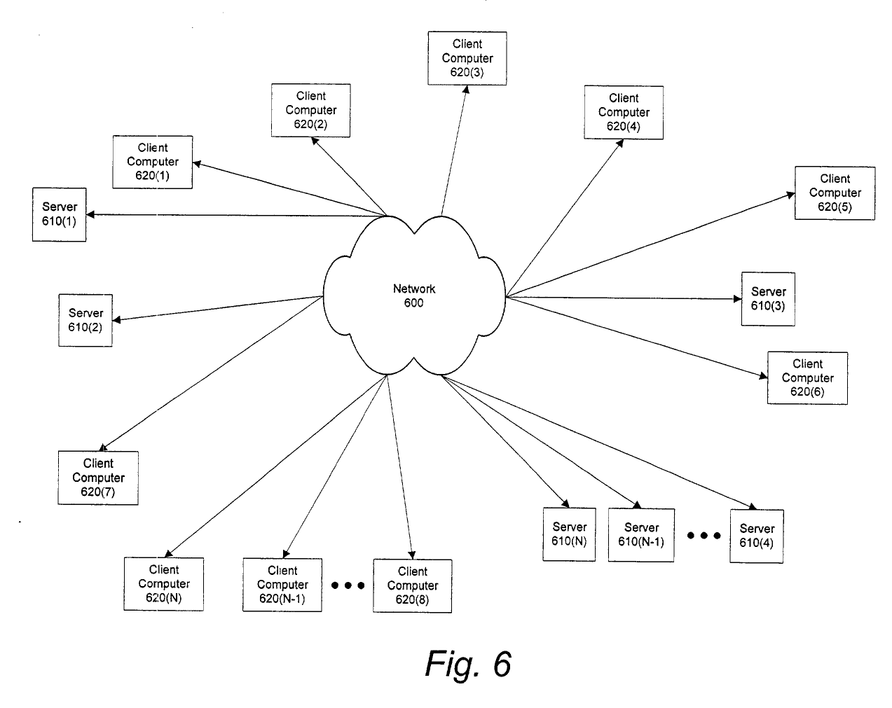

FIG. 6 is a block diagram illustrating a network environment in which a system according to the present disclosure may be practiced. As is illustrated in FIG. 6, network 600, such as a private wide area network (WAN) or the Internet, includes a number of networked servers 610(1)-610(N) that are preferably accessible by client computers 620(1)-620(N). Communication between client computers 620(1)-620(N) and servers 610(1)-610(N) typically occurs over a publicly accessible network, such as a public switched telephone network (PSTN), a DSL connection, a cable modem connection or large bandwidth trunks (e.g., communications channels providing T1 or OC3 service) or wireless link. Client computers 620(1)-620(N) may access servers 610(1)-610(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of client computers 620(1)-620(N).

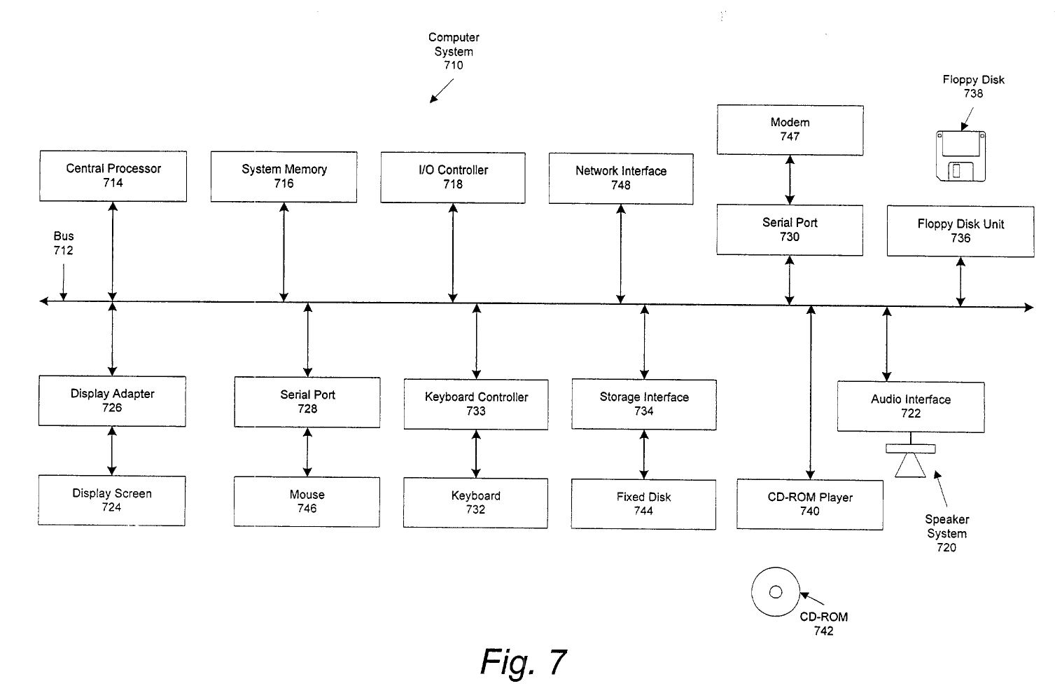

One or more of client computers 620(1)-620(N) and/or one or more of servers 610(1)-610(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (e.g., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 620(1)-620(N) is shown in further detail in FIG. 7.

FIG. 7 depicts a block diagram of a computer system 710 according to teachings of the present disclosure, and an example of one or more of client computers 620(1)-620(N). Computer system 710 preferably includes a bus 712 operable to interconnect a number of subsystems of computer system 710 such as a central processor 714, a system memory 716 (typically RAM, but which may also include ROM, flash RAM, or the like), an input/output controller 718, an external audio device such as a speaker system 720 via an audio output interface 722, an external device such as a display screen 724 via display adapter 726, serial ports 728 and 730, a keyboard 732 (interfaced with a keyboard controller 733), a storage interface 734, a floppy disk drive 736 operative to receive a floppy disk 738, and a CD-ROM drive 740 operative to receive a CD-ROM 742.

Bus 712 typically allows data communication between central processor 714 and system memory 716, which may include both read only memory (ROM) or flash memory (not expressly shown), and random access memory (RAM) (not expressly shown), as previously noted. RAM is generally the main memory into which the operating system and application programs are loaded and typically affords at least sixty-six (66) megabytes of memory space. ROM or flash memory may contain, among other code, a Basic Input-Output system (BIOS) operable to control basic hardware operation such as the interaction with and between peripheral components. Applications resident with computer system 710 are generally stored on and accessed via a computer readable medium, such as a hard disk drive (e.g., fixed disk 744), an optical drive (e.g., CD-ROM drive 740), floppy disk unit 736 or other information storage medium. Additionally, applications may be in the form of electronic signals modulated in accordance with application and data communication technology when accessed via network modem 747 or interface 748.

Storage interface 734, as with the other storage interfaces of computer system 710, may connect to a standard computer readable medium for storage and/or retrieval of information, such as fixed disk drive 744. Fixed disk drive 744 may be a part of computer system 710 or may be separate and accessed through other interface systems. Many other devices may be connected such as mouse 746 connected to bus 712 via serial port 728, modem 747 connected to bus 712 via serial port 730 and network interface 748 connected directly to bus 712. Modem 747 may provide a direct connection to a remote server via a telephone link or to the Internet via an Internet service provider (ISP). Network interface 748 may provide a direct connection to a remote server via a direct network link to the Internet via a POP (point of presence). Network interface 748 may provide such a connection using wireless techniques, including digital cellular telephone connection, general packet radio service (GPRS) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 7 to be present to practice teachings of the present disclosure. The devices and subsystems may be interconnected in ways different from that shown in FIG. 7. The operation of a computer system such as that shown in FIG. 7 is readily known in the art and is not discussed in detail in this application. Code to implement teachings of the present disclosure may be stored in computer-readable storage media such as one or more of system memory 716, fixed disk 744, CD-ROM 742, or floppy disk 738. Additionally, computer system 710 may be any kind of computing device, and so includes personal data assistants (PDAs), network appliances, X-window terminals or other such computing devices. The operating system provided on computer system 710 may be MS-DOS®, MS-WINDOWS®, OS/2®, UNIX®, Linux® or other known operating system. Computer system 710 may also support a number of Internet access tools, including, for example, an HTTP-compliant web browser having a JavaScript interpreter, such as Netscape Navigator® 8.0, Microsoft Internet Explorer® 8.0 and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments may include modified signals in place of directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

With respect to the foregoing described embodiment wherein different components may be contained within different other components (e.g., the various elements shown as components of computer system 710), it is to be understood that such depicted architectures are merely examples and that many other architectures may be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “closely connected”, or “closely coupled”, to each other to achieve the desired functionality.

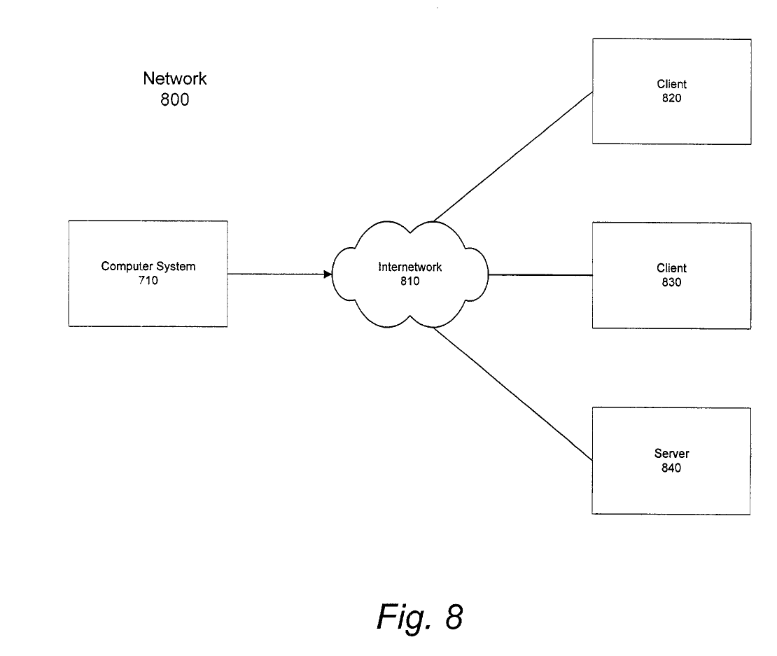

FIG. 8 is a block diagram depicting a network 800 in which computer system 810 is preferably coupled to an internetwork 810, which is preferably coupled, in turn, to client systems 820 and 830, as well as server 840. Internetwork 810 (e.g., the Internet) is also preferably capable of coupling client systems 820 and 830, and server 840 to one another. With reference to computer system 810, modem 847, network interface 848 or some other method can be used to provide connectivity from computer system 810 to internetwork 800. Computer system 810, client system 820 and client system 830 are preferably operable to access information on server 840 using, for example, a web browser (not expressly shown). Such a web browser generally allows computer system 810, as well as client systems 820 and 830, to access data on server 840 representing the pages of a website hosted on server 840. Protocols for exchanging data via the Internet are well known to those skilled in the art. Although FIG. 8 depicts the use of the Internet for exchanging data, the present invention is not limited to the Internet or any particular network-based environment.

Referring to FIGS. 6, 7 and 8, a browser running on computer system 810 preferably employs a transfer control protocol/Internet protocol (“TCP/IP”) connection to pass a request to server 840, which can run an HTTP “service” (e.g., under the WINDOWS® operating system) or a “daemon” (e.g., under the UNIX® operating system), for example. Such a request may be processed, for example, by contacting an HTTP server employing a protocol that can be used to communicate between the HTTP server and the client computer. The HTTP server may then respond to the protocol, typically by sending a “web page” formatted as a hypertext markup language (“HTML”) file. The browser interprets the HTML file and may form a visual representation of the same using local resources (e.g., fonts and colors).

Although the present invention has been described in connection with several embodiments, the invention is not intended to be limited to the specific forms set forth herein, but on the contrary, it is intended to cover such alternatives, modifications, and equivalents as can be reasonably included within the scope of the invention as defined by the appended claims.

What is claimed is:

1. A method for updating communication capabilities in a wireless information handling device comprising:
connecting the wireless information handling device to a server;
determining a software revision status in the wireless information handling device; and
downloading software from the server to the wireless information handling device when the revision status requires software update.

2. The method of claim 1, further comprising initiating a software update when predetermined parameters are met.

3. The method of claim 1, further comprising initiating, by the wireless information handling device, connection to the server.

4. The method of claim 1, further comprising initiating, by the server, connection to the wireless information handling device.

5. The method of claim 1, further comprising connecting to a second server wherein the second server provides additional software files to the wireless information handling device.

6. The method of claim 1, further comprising selecting, by a user, conditions for downloading a software update.

7. The method of claim 1, further comprising connecting the wireless information handling device to the server using an Internet protocol.

8. The method of claim 1, further comprising downloading software to the wireless information handling device using file transfer protocol.

9. A wireless information handling device comprising:
at least one processor;
memory operably coupled to the processor;
a wireless communication component operably coupled to the processor and the memory; and
the wireless information handling device operable to connect the wireless information handling device to a server, determine a revision status of the wireless communication component and download software from the server operable to update al least one wireless communication component functionality.

10. The wireless information handling device of claim 9, further comprising the wireless information handling device operable to initiate an update to the wireless communication component when predetermined parameters are met.

11. The wireless information handling device of claim 9, further comprising the wireless information handling device further operable to initiate connection to the server.

12. The wireless information handling device of claim 9, further comprising the server operable to initiate connection to the wireless information handling device.

13. The wireless information handling device of claim 9, further comprising the wireless information handling device further operable to connect to a second server wherein the second server is operable to provide additional software files to the wireless information handling device.

14. The wireless information handling device of claim 9, further comprising the wireless information handling device operable to respond to user determined conditions for downloading software.

15. The wireless information handling device of claim 9, further comprising using an Internet protocol connection between the server and the wireless information handling device.

16. The wireless information handling device of claim 9, further comprising the wireless information handling device operable to download software using file transfer protocol.

17. An apparatus to update communications capabilities in a wireless information handling device comprising:
means for connecting the wireless information handling device to a server;
means for determining a software revision status in the wireless information handling device; and
means for downloading software from the server to the wireless information handling device when the revision status requires a software update.

18. The apparatus to update communications capabilities in a wireless information handling device of claim 17, further comprising means for initiating a communication component update when predetermined parameters are met.

19. The apparatus to update communications capabilities in a wireless information handling device of claim 17, further comprising the wireless information handling device operable to initiate connection to the server.

20. The apparatus to update communications capabilities in a wireless information handling device of claim 17, further comprising the server operable to initiate connection to the wireless information handling device.

21. The apparatus to update communications capabilities in a wireless information handling device of claim 17, further comprising means for connecting to a second server, the second server operable to provide additional software files to the wireless information handling device.

22. The apparatus to update communications capabilities in a wireless information handling device of claim 17, means for responding to a user determined condition for downloading software.

23. The apparatus to update communications capabilities in a wireless information handling device of claim 17, wherein the connection is made through an Internet protocol.

24. The apparatus to update communications capabilities in a wireless information handling device of claim 17, wherein the downloading of software is performed using file transfer protocol.

25. A computer program for updating communication capabilities in a wireless information handling device comprising:
at least one instruction configured to connect the wireless information handling device to a server;
at least one instruction configured to determine a software revision status of the wireless information handling device; and
at least one instruction configured to download software from the server to the wireless information handling device when the revision status requires software update.

26. The computer program of claim 25, further comprising at least one instruction configured to initiate a wireless information handling device update when predetermined parameters are met.

27. The computer program of claim 25, wherein the wireless information handling device initiates connection to the server.

28. The computer program of claim 25, wherein the server initiates connection to the wireless information handling device.

29. The computer program of claim 25, further comprising at least one instruction configured to connect to a second server, the second server operable to provide additional software files to the wireless information handling device.

30. The computer program of claim 25, wherein a user determines conditions for downloading software.

31. The computer program of claim 25, wherein connection is made through an Internet protocol.

32. The computer program of claim 25, wherein downloading of software is performed using file transfer protocol.
